(19) United States
(12) Patent Application Publication
(10) Pub. No.: US 2025/0334823 A1
(43) Pub. Date: Oct. 30, 2025

(54) TILEABLE HORIZONTAL PARALLAX LIGHT FIELD DISPLAY

(71) Applicant: BARCO N.V., Kortrijk (BE)

(72) Inventor: Dirk Leontine Alfons MAES, Bissegem (BE)

(73) Assignee: BARCO N.V., Kortrijk (BE)

(21) Appl. No.: 18/996,338

(22) PCT Filed: Jul. 13, 2023
(86) PCT No.: PCT/EP2023/069531

§ 371 Date: Jan. 17, 2025

Related U.S. Application Data
(60) Provisional application No. 63/391,131, filed on Jul. 21, 2022.

(51) Int. Cl. G02B 30/10

(52) U.S. Cl. CPC G02B 30/10

(57) ABSTRACT

A tileable collimated multi-view pixel display with horizontal parallax, comprising a novel arrangement of horizontal parallax multi-view pixel elements that are placed in front of a collimated pixel display. The display provides a horizontal parallax multi-view pixel element out of an arbitrary portion of a collimated pixel display of M horizontal by N vertical pixels (collimated pixel display portion) to generate M×N unique horizontal viewing directions.

### FIELD OF THE INVENTION

The invention relates to multi-view autostereoscopic displays with horizontal parallax, also sometimes called light field displays. More specifically, the invention relates to a novel arrangement of horizontal parallax multi-view pixel elements that are placed in front of a collimated pixel display.

### BACKGROUND OF THE INVENTION

Stereoscopic displays that are depending on viewing aides (specially adapted 3D-glasses) have limited success in the market. Often the need to wear glasses by the observer is inconvenient, and in some applications not even possible. It is therefore that other solutions have been sought after to rid this constraint.

Lenticular lens 3D displays (sometimes called glasses-free multi-view displays) have been proposed that are grouping a number of pixels under a lens element to send the light from the different pixels in different directions to give an illusion of depth. This approach comes however at the cost of a reduction in spatial resolution of the display.

In many applications it is sufficient to provide the parallax effect only in the horizontal direction. This can be achieved for example by means of a parallax barrier or a cylindrical lenticular lens that is applied in front of an image or an image display. While in this case the vertical spatial resolution (i.e. displayed number of pixels) of the display remains unaltered, the horizontal resolution is divided by the number of views that are created to support the same number of viewing angles.

The parallax effect can only be achieved when different views can be delivered to the two eyes of the observer. As such, a different image has to be delivered to left and the right eye. The spacing of the views has to be small enough to present a viewer at the maximum viewing distance with at least a different perspective at the position of the left eye versus the position of the right-eye. Therefore the light beams projected towards the viewer have to accurately collimated to achieve this effect; cross-talk between adjacent views has to be avoided.

In EP0791847, an approach is proposed to take advantage of the vertical RGB stripe pattern of the pixels, by slanting the cylindrical lenticular lenses across the RGB matrix surface of the display and increase the number of horizontal views by a factor 3, while dividing the vertical resolution by 3. This is illustrated in FIG. 1. This configuration is very effective for a 9-view display, where a balance between horizontal and vertical resolution is restored, yet it also introduces undesired crosstalk between adjacent images. A drawback of such a configuration is however that it cannot be expanded to a higher number of views. Expanding the slanted lenticular approach to a higher number of vertical lines (for example 6× or 9×) would result in extreme cross-talk between adjacent views, blending the views together resulting in an unusable system. In other words this slanted lenticular approach does not scale well to take advantage of high resolution displays currently available on the market.

Even when applying the slanted lenticular structure and with high resolution displays becoming available, it remains challenging to offer a high number of views at an acceptable resolution.

A way to mitigate this is to apply optical view replication, where the same set of multiple views are replicated in a number of discrete viewing zones. In this case, the light from the same pixel passes through a number of adjacent slits in a parallax barrier or adjacent elements of the cylindrical lenticular lens. The downside of this technique is that it restricts the viewer positions to a limited number of well defined viewing zones. This is illustrated in FIG. 2. The problem is that in the transitory zones (illustrated by the white eye boxes in FIG. 2) between the intended viewing zones a mix of left and right perspectives is observed, and that it is even possible to observe stereo inversion when the right eye coincides with the position of a left-eye-perspective, while the left eye coincides with the position of a right-eye-perspective. This results is a very confusion effect for the viewer. Also the freedom to move closer or further away from the display is very limited.

The optical view replication achieved in the solution described above is not applicable to create a multi-view display where from every direction a different perspective can be observed. And therefore, no light can be tolerated to enter the adjacent lens element. For pixels near the boundaries of the cylindrical lenticular lens this becomes difficult to avoid. Especially since the front glass of the LCD and the lenticular lens substrate have a certain thickness.

A cylindrical lenticular lens is often presented as a lens that deflects the light only in 1 direction while leaving the light in the orthogonal direction unaffected. However this is only approximately true for very small angles. After all the Snell's law of optical refraction is a non-linear one. For a wide viewing angle multi-view display this can no longer be neglected. Where ideally for every view, a vertical strip of light should be generated in space, a tilted cylindrical lenticular lens will generate a bow of light in space. This is illustrated in FIG. 3. While the small offset in viewpoint might be deemed to be acceptable, the bigger problem is that it results in poor control over the transition between adjacent views (spill-over).

In order to increase the size of a multi-view 3D display, tiling of LCDs has been demonstrated as a concept. However where seams are always a disturbance, even in 2D images, they become more problematic for a 3D display. When the 3D object is placed behind the display plane, it remains acceptable (like looking through a partitioned window). However for objects placed in front of the display plane cutting information away by the bezels in between the display areas feels very unnatural and ruins the 3D experience.

Tiling of LCD displays with an edge-to-edge seam of only 1 mm has been demonstrated.

There is a need for a glasses-free 3D display that provides a high number of horizontal views, without restricting the position of the viewer to defined sweet spots. The perspective view of the viewer should change as he moves left/right in front of the display and the amount of parallax should naturally increase or decrease as the viewer moves closer or further away from the display respectively. End the end, it should be the purpose to create a viewing experience that resembles the experience of moving around in front of a real 3D object. These horizontal views should be independent with minimal cross talk between adjacent and neighbouring views. A controlled transition between adjacent views is required to avoid dark zones in between views, while at the same time minimizing the extent of this transition zone. Cross talk between neighbouring non-adjacent views should be minimized. A defined horizontal view should be observable over a defined range of vertical angles, in other words a defined horizontal view should generate a vertical strip of light, not a bow.

Ideally, the overall size and spatial resolution of 3D displays should be scalable such that sufficient views can be generated and such that the spatial resolution of the displayed object is sufficiently high to be give a natural representation of the displayed object.

### SUMMARY OF THE INVENTION

It is first object of the invention to provide a horizontal parallax multi-view pixel element out of an arbitrary portion of a collimated pixel display of M horizontal by N vertical pixels (collimated pixel display portion) to generate M×N unique horizontal viewing directions. The light from each of the pixels in the M by N matrix being collimated. A freeform lenslet array receiving the collimated light from the M by N collimated pixel display portion and directing light from each pixel into a defined horizontal viewing angle while spreading the light over a range of vertical viewing angles. Each element of the freeform lenslet array being aligned to a single pixel of the M by N collimated pixel display portion. A freeform lenslet array is thus a combination of M×N lenslet elements that produces the different light beams for the M×N different views. The term “freeform” indicates an optical surface that lacks translational or rotational symmetry about axes normal to the main plane, as opposed to conventional flat, spherical, aspherical and cylindrical optical surfaces. The multi-view pixel element delivering M×N unique discrete horizontal viewing angles with constant spacing between adjacent horizontal viewing angles. In the context of the invention, a pixel may comprise subpixels, for example red, green and blue subpixels, and a lenslet element may comprise 2 or more, freefrom sublenslet elements to receive collimated light from 1 or more subpixels of which the light is directed into one of the M×N unique discrete horizontal viewing angles while spreading the light over a range of vertical viewing angles.

It is a further object of the invention that the freeform lenslet or sublenslet element surface for each of the pixels or subpixels is shaped such that the horizontal angle is substantially constant over the range of vertical angles, thereby producing a vertical strip of light into the viewing zone. Wherein substantially constant horizontal angle means that the spread of the horizontal angles over the range of vertical angles of interest is preferably smaller than the angular spacing between adjacent horizontal views and at least smaller than twice the angular spacing between adjacent horizontal views.

It is a further object of the invention that the horizontal degree of collimation of the collimated light is precisely controlled to close the gaps between adjacent horizontal viewing angles, while minimizing the overlap between adjacent horizontal views. Collimated light has near parallel rays, and therefore will spread minimally as it propagates. A perfectly collimated light beam, will have no divergence. The horizontal collimation angle being larger than or equal to the angular gap between adjacent horizontal views and smaller than twice the angular gap between adjacent horizontal views. And the horizontal angular profile of the collimated light being controlled to deliver approximately constant brightness over the entire range of horizontal viewing angles in between two adjacent horizontal views.

It is a further object of the invention that pixels or subpixels for a positive horizontal viewing angle are interleaved with pixels or subpixels of a substantially complementary negative horizontal viewing angle, in order to avoid steep transitions between horizontally adjacent lenslet or sublenslet elements. Two such adjacent pixels with complementary horizontal viewing angle creating a pixel pair.

It is a further object of the invention that pixel pairs are arranged in a vertical zigzag order of increasing absolute value of horizontal viewing angle, in order to minimize steep transitions between vertically adjacent lenslet or sublenslet elements and maintain a nearly constant spacing between multiview pixels of adjacent horizontal viewing angle.

It is a second object of the invention to tile different display modules containing multi-view pixel elements together to achieve a large format high resolution multi-view 3D display. The seam between adjacent display modules being as small as possible and introducing a virtual gap of unused pixels (that are set to black) with dimensions similar to the seam width that is repeated between adjacent multi-view pixel elements. Such that the spacing between multi-view pixels is substantially constant over the entire display area, providing a seamless continuous image across the full 3D display.

It is a third object of the invention to provide a collimated backlight structure for such a tileable multi-view display with a group of multi-view pixels clustered to be illuminated by a collimated backlight cell. Such a collimated backlight cell containing at least a lightsource and a collimation lens. And where a light absorbing structure is installed in between adjacent collimated backlight cells to avoid light spill-over from one light source to the adjacent collimation lens. And where the joint between adjacent collimation lenses and the light absorbing supporting structure are aligned with the virtual gaps of unused pixels such that the transition between collimated backlight cells remains invisible to the user.

It is a further object of the invention of the collimated backlight cell that a tapered uniformization rod may be placed in front of the light source to alter the emission angles in a vertical, horizontal or vertical and horizontal direction

It is a further object of the invention of the collimated backlight cell that a reflective polarizer may be installed after the light source or after the tapered rod. The reflective polarizer being aligned to pass only light with the proper polarization direction for the LCD display. And recycling the light with the wrong polarization direction back to the light source, which is assumed to be a blue LED light source with yellow phosphor. The recycling contributing to the useful polarized yellow light output by additional conversion of recycled blue light and unpolarized reflection of recycled yellow light.

It is a further object of the invention of the collimated backlight cell that a lens may be installed to receive the light from the light source or from the tapered rod and focus the light into an aperture plane.

It is a further object of the invention of the collimated backlight cell that a round or oval shaped aperture may be placed at the focal plane of the collimation lens in order to finetune the collimation angle and a achieve the precise control over the horizontal angular profile to deliver approximately constant brightness over the entire range of horizontal viewing angles in between two adjacent horizontal views.

It is a fourth object of the invention that the multiple light sources from the collimated backlight structure are individually dimmed, and the dimming level is determined by the brightest view within the cluster of multi-view pixels comprised in the respective collimated backlight cell. Thereby reducing power consumption and improving the black level.

Tiling of 3D display modules should be enabled both to increase the overall size of the display and to increase the resolution. Such tiling should be visually seamless to enable the 3D image to be placed not only behind the display layer but also in front of this layer.

The matrix of M by N pixels results in M×N independent horizontal views with minimal cross talk between neighboring non-adjacent views. It is an advantage of the invention that the solution can scale to any number of M and N, enabling to take full advantage of displays with high horizontal and vertical resolution.

Each horizontal view is observable over a range of vertical viewing angles resulting in a vertical strip of light.

The transition between adjacent views is precisely controllable, by controlling the degree of collimation from the backlight structure, such that on the one hand dark zones between adjacent views are avoided, and on the other hand bright zones due to too much overlap are also avoided. A flat field image without 3D depth as a result should be viewable from any viewer position in front of the screen as an image of substantially constant brightness and color.

The solution is tileable to enable scaling to large format displays with high resolution, in-spite-of the reduction of the horizontal resolution by a factor M and a reduction of the vertical resolution by a factor N.

Tiling is visually seamless as the seam between tiles is identical to the inactive area between the multi-view pixel elements within the tile itself. This enables 3D objects to be reproduced behind as well as in front of the display layer. Note that the inactive area between the multi-view pixel elements could be smaller or larger than the seam between tiles, if the brightness of pixels near the edge of the tile is increased or decreased respectively to compensate for the difference in spacing.

The collimated backlight structure can be divided into compartments by taking advantage of the inactive zones between multi-view pixel elements. These compartments avoid light spill-over between adjacent light sources.

By using multiple light sources for the backlight each located in such a compartment, the depth of the backlight structure can be reduced. Further local dimming of these individual light sources as a function of image content can increase display contrast and reduce power consumption.

Given the collimated nature of the backlight, the distance between the LC layer and the freeform lenslet array surface is not critical.

By defining the free-form sublenslet elements per subpixel rather than per pixel, the lens sag (peak-to-valley) can be limited, facilitating the lenslet array reproduction.

By interleaving subpixels from a positive horizontal angle with subpixels from an approximately identical negative horizontal angle, steep transitions between adjacent lenslet or sublenslet elements are avoided in the horizontal direction. By organizing the lenslet or sublenslet elements in a vertical zigzag order with increasing absolute value horizontal angle, steep transitions between adjacent lenslet or sublenslet elements are avoided in the vertical direction. Avoiding steep transitions further facilitates the lenslet array reproduction and eliminates unwanted total internal reflections

The optional use of a tapered rod in the backlight structure enables to capture the full emission angle of an LED light source with a collimation lens thereby increasing the light efficiency of the backlight structure and thus reducing power consumption.

The optional use of a reflective polarizer in the backlight structure after the light source or after the tapered rod enables to recycle light with the wrong polarization, that would otherwise be blocked by the LCD polarizer. Thereby further increasing light efficiency of the backlight structure and thus further reducing power consumption.

Multiple multi-view lens elements may be combined on a single substrate and be replicated in a single step. For large displays it is advantageous to work with relatively small substrates to achieve precise registration of each lenslet or sublenslet element with its corresponding pixel or subpixel. By aligning the transitions between those substrates with one of the inactive zones between multi-view pixel elements, those transitions remain invisible to the viewer and a gap between substrates can be tolerated to facilitate alignment.

### BRIEF DESCRIPTION OF THE DRAWINGS

FIG. 1: Illustrates a prior art horizontal parallax display with slanted lenticular lens, clustering 3×3 pixels to generate 9 views.

FIG. 2: Illustrates a prior art auto-stereoscopic parallax barrier display with optical view replication generating multiple left and right perspective viewing zones.

FIG. 3: Illustrates the vertical angular distribution from a cylindrical lenticular lens surface, when this surface is tilted to obtain a large horizontal deflection angle.

FIG. 4: Illustrates a preferred embodiment of the invention

FIG. 5: Illustrates the vectorial refraction law

FIG. 6: Illustrates the refracted beam vector V̅2̅ as a function of the horizontal and vertical deflection angles.

FIG. 7: Illustrates the surface normal vector ā as a function of the horizontal and vertical tilt of the surface

FIG. 8: Illustrates the evolution of the surface horizontal tilt in the center, and the surface horizontal and vertical tilt near the edge of the freeform surface with increasing horizontal view angle

FIG. 9: Illustrates the surface curvature of the front and back surface to obtain a constant horizontal deflection angle and the approximation of those cross sections with an ellipse fit

FIG. 10: Illustrates the evolution of the short and long axis of the fitted ellipses for increasing horizontal deflection angles

FIG. 11: illustrates 2 RGB sub-pixelated pixels and a beam deflection unit having a freeform surface defined per subpixel. Positive and negative beam deflection surfaces are interleaved to avoid sharp transition edges in between subpixels.

FIG. 12: Shows the vertical angle distribution for a positive 30° horizontal beam deflection angle as obtained from the freeform surface with elliptical approximation

FIG. 13: Shows how pixel pairs of free-from beam deflection units are organized in a matrix of 6 horizontal by 12 vertical pixel pairs using a vertical zigzag order of increasing horizontal deflection angles

FIG. 14: Shows the resulting freeform surface covering each multi-view pixel containing 12×12 pixels

FIG. 15: Shows the 144 vertical stripes generated by the multi-view pixel with a nearly perfectly collimated backlight

FIG. 16: Shows the uniform angular distribution when a controlled amount of horizontal angular spread is added to the collimated backlight to eliminate the gaps between adjacent views

FIG. 17: Shows a preferred embodiment of a seamlessly tiled multi-view display

FIG. 18: Shows preferred embodiments of a collimated backlight structure for the seamlessly tiled multi-view display

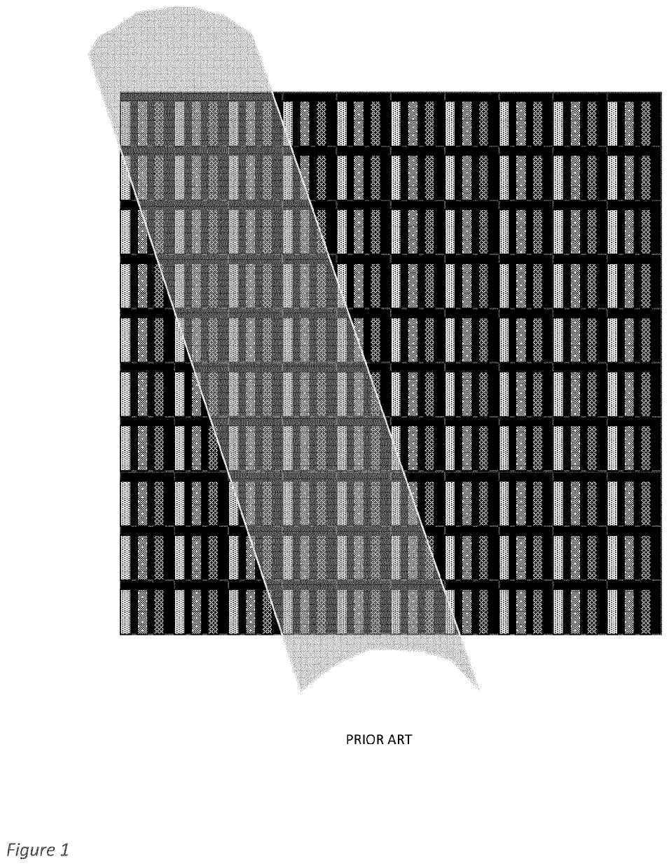

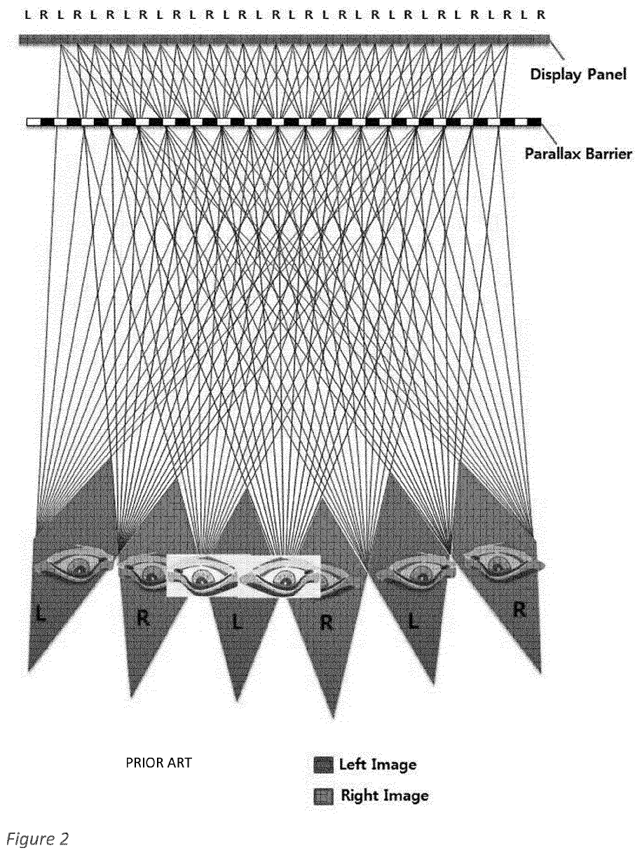

### DETAILED DESCRIPTION OF EMBODIMENT(S)

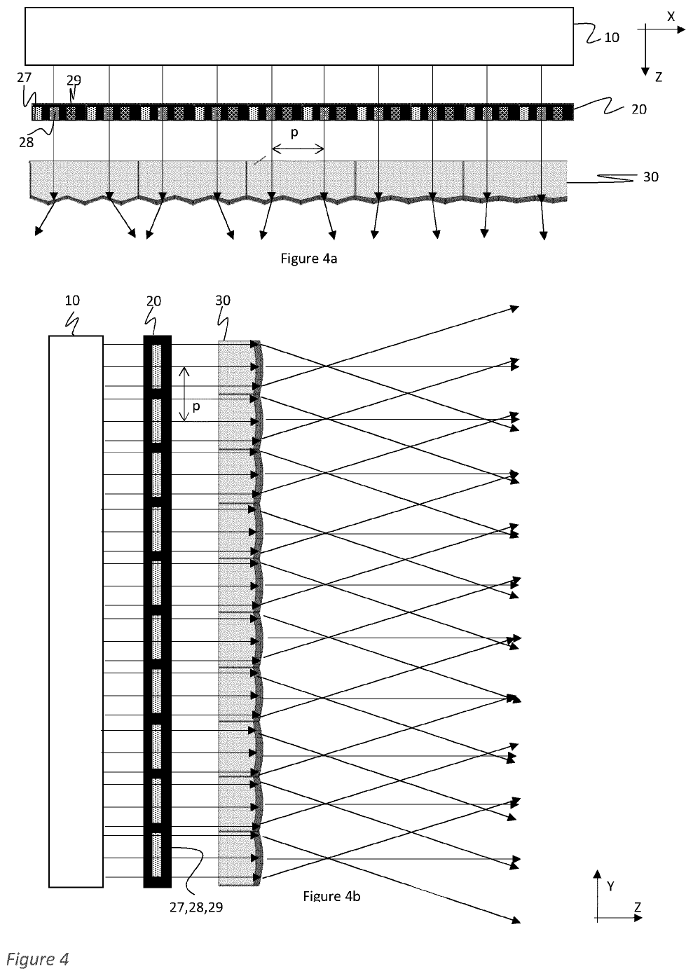

FIG. 4 illustrates a preferred embodiment of the invention. A collimated backlight 10 is illuminating a liquid crystal display 20. The liquid crystal display (LCD) comprises pixels spaced with a pitch p in horizontal and vertical direction. Each pixel of the LCD may comprise different subpixels 27,28 and 29. For example to produce red, green and blue colored subpixel images. The subpixels preferably extend over substantially the entire vertical area of the pixel while covering<⅓ of the horizontal area of the pixel. Further referred to as vertical subpixels. A matrix of M horizontal pixels by N vertical pixels is grouped to create a multi-view pixel area. The collimated light from the backlight 10 modulated by the M×N pixel matrix of the LCD 20 results in a collimated multi-view pixel display. A freeform lenslet array 30 is installed between the LCD 20 and the viewing zone to receive light from the collimated multi-view pixel display. Preferably each element of the freeform lenslet array 30 receives the light from 1 pixel of the collimated multi-view pixel display and refracts it into a defined horizontal viewing direction while spreading out the light in the vertical direction. The array of M horizontal by N vertical pixels can thus be used to provide M×N unique horizontal viewing directions. The spreading of the light in vertical direction will make sure that a viewer in front of the display can observe the horizontal view regardless of his eye height relative to the height of the pixel.

The horizontal views of the multi-view pixel image are spaced apart with a constant increase of the horizontal viewing angle. The degree of horizontal collimation of the light propagated from the collimated multi-view image is precisely controlled to fill the angular gap between adjacent horizontal viewing angles and create a minimal overlap zone where light from adjacent views is mixed in such a way that overall the light intensity remains constant over the entire range of horizontal viewing angles between two adjacent horizontal views, thereby avoiding dark zones, as well as bright zones.

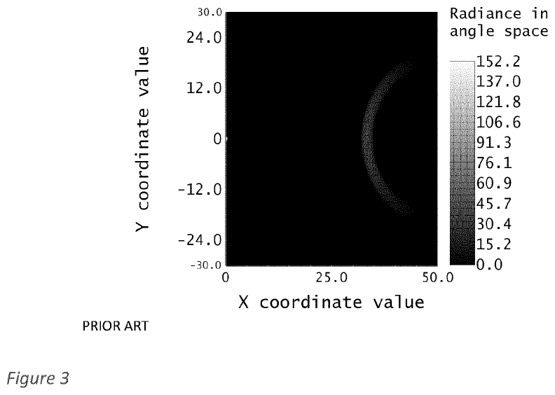

The degree of collimation in the vertical direction may be identical, smaller or larger than the degree of collimation in the horizontal direction, but should be sufficiently small to avoid the bending of the viewing zone as illustrated in FIG. 3. Preferably the vertical collimation angle is smaller than 5°.

More preferably each element of the freeform lenslet array 30 receives the light from 1 subpixel of the collimated multi-view pixel display and refracts it into a defined horizontal viewing direction while spreading out the light in the vertical direction. Subpixels that contribute to the same horizontal viewing direction may each have a tailored free-form lens element, to produce as much as possible identical horizontal and vertical viewing angle characteristics for each of the three colors. Note that these subpixels contributing to the same horizontal viewing direction, are not necessarily adjacent. In FIG. 4 for example red and blue subpixels of horizontal pixel N are grouped with the green subpixel of horizontal pixel N+1 to deliver a first horizontal viewing angle. While the green subpixel of horizontal pixel N is grouped with the red and blue subpixel of horizontal pixel N+1 to deliver a second horizontal viewing angle. The first horizontal angle and the second horizontal angle being substantially complementary. Such an arrangement avoids steep transitions between adjacent lenslet or sublenslet elements.

### Definition of the Freeform Lenslet or Sublenslet Element Surface

It is an object of the invention to define a freeform lenslet or sublenslet element surface that receives a collimated light beam from a subpixel or pixel out of the collimated multi-view pixel image and refracts the light into a range of vertical angles with a substantially constant horizontal viewing angle. Thereby producing a vertical strip of light into the viewing zone. Substantially constant horizontal angle means that the deviation in the horizontal angle over the range of vertical angles preferably is smaller than the horizontal angular spacing between adjacent views and at least smaller than twice the horizontal angular spacing between adjacent views.

FIG. 5 Illustrates the vectorial refraction law wherein:
S̅1̅=incident ray vector with magnitude n1
S̅2̅=outgoing ray vector with magnitude n2
n1=refractive index of the incident medium
n2=refractive index of the outgoing medium
θ1=incident angle
θ1=outgoing angle
Ā=normal vector with magnitude n2·cosθ2−n1·cosθ1

Vectorial refraction law: S̅2̅=S̅1̅−Ā

In our application, we know the incident vector S̅1̅ which is parallel with the z-axis and has a magnitude n, the refractive index of the freeform lens material.

$$\overline{S 1} = n \cdot z$$

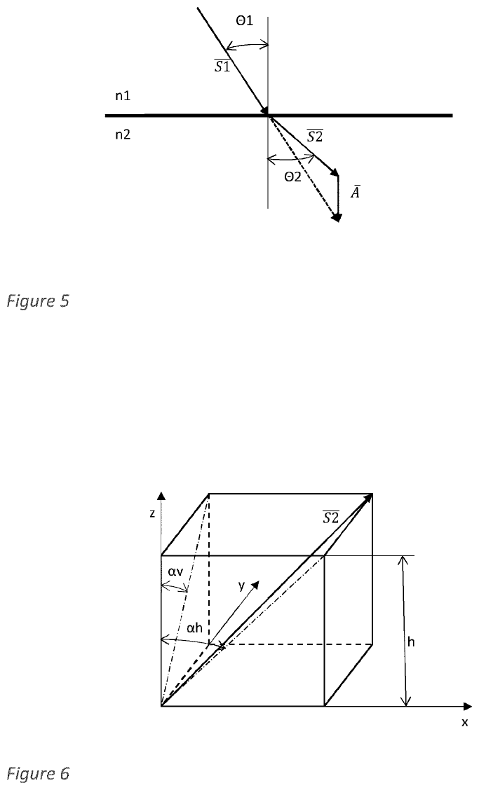

In FIG. 6 it is illustrated how we can define the desired outgoing vector S̅2̅, by the horizontal refraction angle αh and the vertical refraction angle αv, with the refractive index of air equal to 1. When we define height h as the projection of the vector S̅2̅ onto the Z-axis.

$$\overline{S 2} = h \cdot tan α h \cdot x + h \cdot tan α v \cdot y + h \cdot z$$

For any given combination of αh and αv, we want to determine the normal vector Ā. Where from the vectorial refraction law we derive:

$$\overline{A} = \overline{S 1} - \overline{S 2}$$

Substituting the above equations for S̅1̅ and S̅2̅:

$$\overline{A} = n \cdot z - ( h \cdot tan α h \cdot x + h \cdot tan α v \cdot y + h \cdot z )$$

Which can be rewritten to:

$$\begin{matrix}\overline{A} = - h \cdot tan α h \cdot x - h \cdot tan α v \cdot y + ( n - h ) \cdot z\end{matrix} \qquad Equation 1$$

We can determine h from the vectorial law that the sum of the squares of the direction cosines of the unity vector of S2 has to be equal to 1:

$$Equation 2$$

$${( tan α h \cdot h )}^{2} + {( tan α v \cdot h )}^{2} + {h}^{2} = 1 \text{=>} {h}^{2} ( {( tan α h )}^{2} + {( tan α v )}^{2} + 1 ) = 1 \text{=>} \begin{matrix}h = \sqrt{\frac{1}{1 + {( tan α h )}^{2} + {( tan α v )}^{2}}}\end{matrix}$$

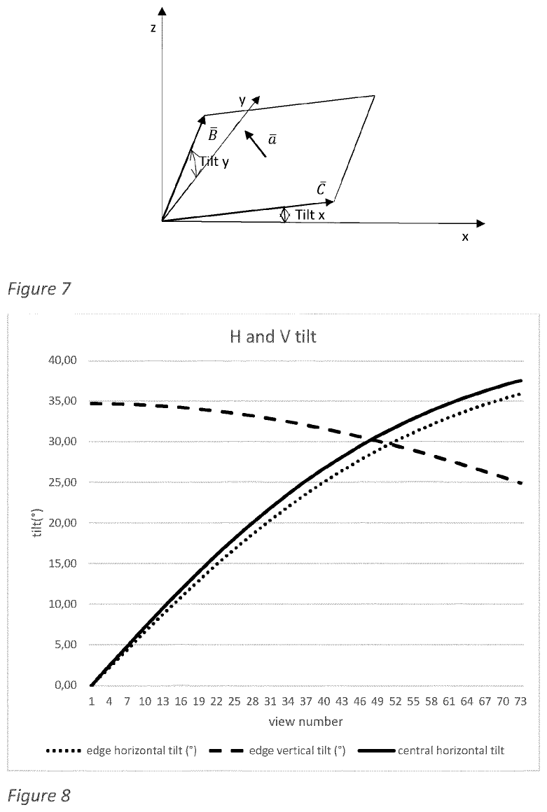

In FIG. 7 we define the surface normal unity vector α̅ as a combination of a horizontal tilt angle tiltx and a vertical tilt angle tilty

The surface normal unity vector α̅ is defined by the vectorial product C̅×B̅

$$With \overline{C} = cos ( tiltx ) \cdot x + 0 \cdot y + sin ( tiltx ) \cdot z$$

$$And \overline{B} = 0 \cdot x + cos ( tilty ) \cdot y + sin ( tilty ) \cdot z$$

The vectorial product:

$$\overline{C} \times \overline{B} = ( Cy \cdot Bz - Cz \cdot By ) \cdot x + ( Cz \cdot Bx - Cx \cdot Bz ) \cdot y + ( Cx \cdot By - Cy \cdot Bx ) \cdot z \text{=>} \overline{C} \times \overline{B} = - cos ( tilty ) \cdot sin ( tiltx ) \cdot x - cos ( tiltx ) \cdot sin ( tilty ) \cdot y + cos ( tiltx ) \cdot cos ( tilty ) \cdot z$$

Vector Ā is defined by its unity vector α̅ and its amplitude: ampl A

$$Equation 3$$

$$\overline{A} = ampl A \cdot ⌊ - cos ( tilty ) \cdot sin ( tiltx ) \cdot x - cos ( tiltx ) \cdot sin ( tilty ) \cdot y + cos ( tiltx ) \cdot cos ( tilty ) \cdot z ⌋$$

From equation 1 and equation 3 we can derive three equations:

$$\frac{- h \cdot tan ( α h )}{ampl a} = - cos ( tilty ) \cdot sin ( tiltx ) \qquad Equation 4$$

$$\frac{- h \cdot tan ( α v )}{ampl a} = - cos ( tiltx ) \cdot sin ( tilty ) \qquad Equation 5$$

$$\frac{n - h}{ampl a} = cos ( tiltx ) \cdot cos ( tilty ) \qquad Equation 6$$

From equation 6

$$ampl a = \frac{n - h}{cos ( tiltx ) \cdot cos ( tilty )}$$

Substituting in equation 4

$$\frac{- h \cdot tan ( α h )}{n - h} = - \frac{cos ( tilty ) \cdot sin ( tiltx )}{cos ( tiltx ) \cdot cos ( tilty )} \text{=>} \frac{tan ( α h )}{\frac{n}{h} - 1} = tan ( tiltx ) \qquad Equation 7$$

$$\\ \begin{matrix}\text{=>} tiltx = {tan}^{- 1} [ \frac{tan ( α h )}{\frac{n}{h} - 1} ]\end{matrix}$$

Substituting in equation 5

$$\frac{- h \cdot tan ( α v )}{n - h} = - \frac{cos ( tiltx ) \cdot sin ( tilty )}{cos ( tiltx ) \cdot cos ( tilty )} \text{=>} \frac{tan ( α v )}{\frac{n}{h} - 1} = tan ( tilty ) \qquad Equation 8$$

$$\\ \begin{matrix}\text{=>} tiltx = {tan}^{- 1} [ \frac{tan ( α v )}{\frac{n}{h} - 1} ]\end{matrix}$$

From equations 2, 7 and 8 we can calculate the horizontal tilt (tiltx) and vertical tilt (tilty) of the freeform lens surface required to deliver the requested horizontal deflection angle (αh) and vertical deflection angle (αv) for a given refractive index (n).

A detailed design example is presented for a 144-view horizontal parallax tileable display, based on a 4K (3840×2160 pixels) 55″ LCD display module with a pixel pitch p=0.315 mm. A matrix of 12×12 pixels is combined in 1 multi-view pixel covered with a free-form lenslet array surface 30. We aim at a horizontal viewing angle ranging from −36° till+35.5° with a horizontal angular spacing of 0.5°. At the same time we aim at a vertical viewing angle of +/−25°.

FIG. 8 presents the evolution of the horizontal tilt in the vertical center of the pixel, or subspixel, corresponding to the central vertical viewing angle of 0° (central horizontal tilt in a solid line), and the horizontal tilt at the vertical edge of the pixel or subpixel (edge horizontal tilt in dotted line) as well as the vertical tilt at the same edge position (edge vertical tilt in dashed line). The edge position corresponding to the maximum vertical viewing angle of +25° or −25°. For view numbers increasing along the x-axis from 0 (horizontal view angle=) 0° till 72 (horizontal view angle=−36°). The results are calculated from equations 2,7 and 8. It can be seen that the edge horizontal tilt (for a fixed vertical angle of −25°) is increasing slower than the central horizontal tilt (for a fixed vertical angle of 0°). In other words the horizontal tilt angle is reduced from the center to the edge, and more so as the horizontal view angle (in absolute value) is increasing. At the same time the edge vertical tilt angle is decreasing as the horizontal view angle (in absolute value) is increasing. This illustrates the non-linear behavior of the refraction law, and the fact that the horizontal tilt angle and vertical tilt angle are mutually dependent as a result.

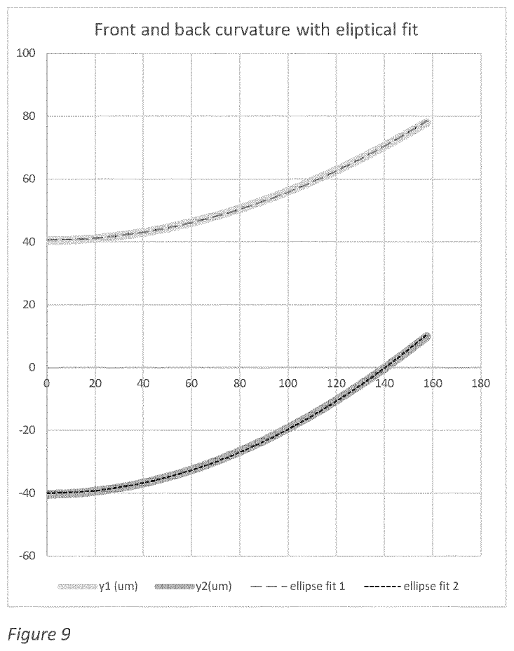

FIG. 9 illustrates the shape of the curvature of a negative freefrom lens aiming to deliver a fixed horizontal viewing angle of 30°, while spreading the light over a vertical angle of +/−25°. For every vertical position of the subpixel going from 0 μm (center of the pixel) to 157.5 μm (top of the subpixel) we calculate the horizontal tilt and vertical tilt angle of the surface using equations 2,7 and 8. We than determine the curvature of the surface at the left position of the subpixel (cross section at position x=−57.5 μm) illustrated with y2 (dark gray line) and the curvature of the surface at the right position of the subpixel (cross section at position x=+57.5 μm) illustrated with y1 (light gray line).

The full lens surface will be symmetrical around vertical axis of the graph (note however this axis corresponds to the horizontal axis of the multi-view display).

It should be clear that the choice for a negative lens surface here is arbitrary and that a positive lens could achieve the same result.

Both curve y1 and y2 can be reasonably well fitted with an ellipse as shown by curves ellipse fit 2 (dark gray dotted line) and ellipse fit 1 (light gray dotted line). We see that the elliptical cross section at the high side of the lens element is more shallow than the elliptical cross section at the low side of the lens element.

The ellipses are defined by equation:

$$\frac{{( y - h )}^{2}}{{a}^{2}} + \frac{{( z - k )}^{2}}{{b}^{2}} = 1$$

### Wherein:

a=length of the axis of the ellipse along to the Y-axis (vertical axis of the display)
b=length of the axis of the ellipse along the Z-axis (direction of the collimated backlight)
h=the central Y coordinate of the ellipse
k=the central Z coordinate of the ellipse

In a preferred embodiment, we set h=0, which means that the vertical center of the ellipse coincides with the vertical center of the lenslet or sublenslet element, and therefore the lenslet or sublenslet element is symmetrical along the horizontal axis of the pixel or subpixel, resulting in a symmetrical vertical viewing angle. In another preferred embodiment it could be desirable to design for an asymmetrical vertical viewing angle in which h would be different from zero.

Multiple ellipses may fit the curve of FIG. 9. In a preferred embodiment this may be constrained by setting k to be identical for the front and back ellipse, and even keep k constant for all lenslet or sublenslet elements of the freeform lenslet array 30.

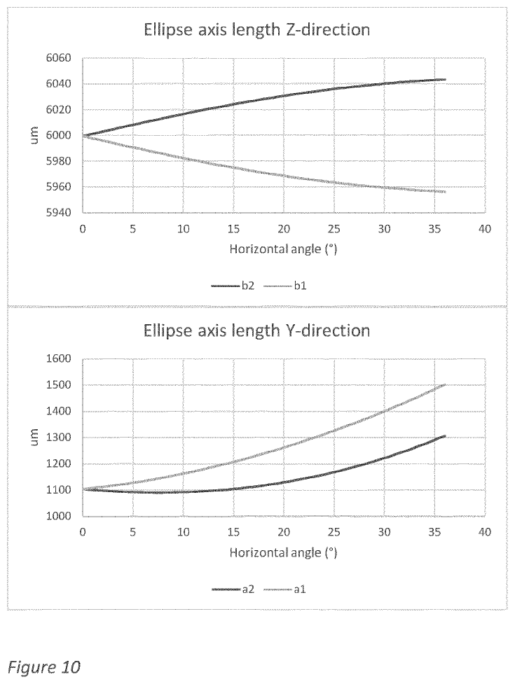

FIG. 10 illustrates the evolution of the front and back ellipse parameters with increasing absolute value of the horizontal viewing angle when k is set to 6000 μ. The front ellipse is defined by parameters a2 and b2, the back ellipse is defined by parameters a1 and b1. When the horizontal viewing angle is 0°, the front and back ellipses are identical (b1=b2 and a1=a2). So in this case the horizontal tilt of the freeform surface is 0 as expected.

But as the horizontal viewing angle increases (in absolute value), b2 increases while b1 decreases. This means that the horizontal centerline of the freeform lenslet or sublenslet element is increasingly tilted to provide an increasing horizontal deflection angle; which is to be expected. But it is interesting to note that this increase in the tilt of the horizontal centerline of the freeform surface with increasing horizontal viewing angle (in absolute value) is slower than linear.

As the horizontal viewing angle increases (in absolute value), also the parameter a1 increases. And parameter a2 goes down a bit initially but then also starts to increase. This means that the lens sag of the freeform lenslet or sublenslet element surface becomes smaller for large horizontal viewing angles (in absolute value). We also observe an increased difference between a1 and a2; or the back ellipse, at the high side of the lenslet or sublenslet element, becomes shallower than the front ellipse, at the low side of the lenslet or sublenslet element, and more so when the horizontal viewing angle increases (in absolute value). Both ellipses become more shallow as the horizontal viewing angle becomes larger (in absolute value).

This confirms the earlier finding illustrated in FIG. 8 that the edge horizontal tilt becomes increasingly smaller than the central horizontal tilt as the horizontal viewing angle increases (in absolute value).

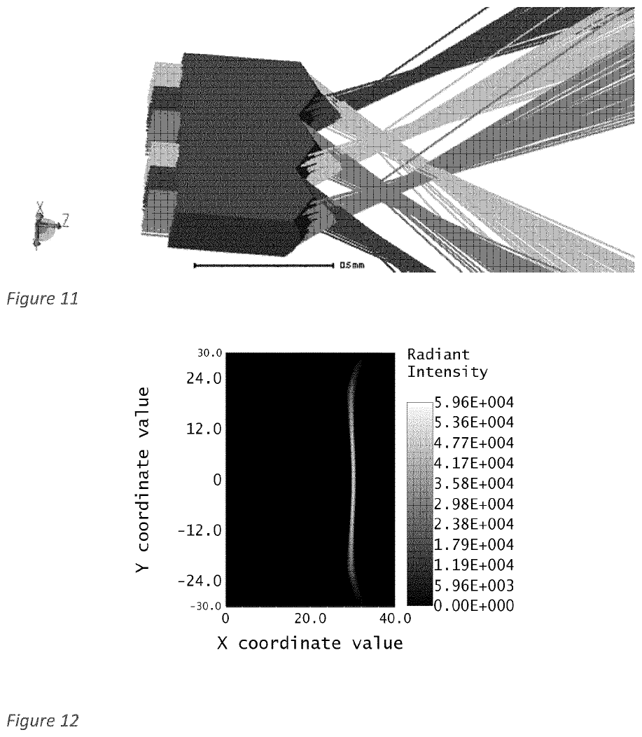

As the front and back ellipse parameters grow further and further apart with increasing horizontal viewing angle (in absolute value), this starts to result in steep transitions between lenslet or sublenslet elements of adjacent pixels or subpixels. Such steep transitions are difficult to achieve with molding techniques and may result in unwanted total internal reflections of the collimated multi-view image at those transitions. In a preferred embodiment illustrated in FIG. 11, such steep transitions are avoided by interleaving pixel or subpixels for a positive horizontal viewing angle with pixels or subpixels for a substantially complimentary negative horizontal viewing angle. Note that such a complementary negative horizontal viewing angle is achieved by interchanging the front and back ellipse parameters from the positive horizontal viewing angle.

For example a lenslet or sublenslet element for an horizontal angle of +10° is put adjacent to a lenslet or sublenslet element for an horizontal angle of −9.5°. The parameters of the back ellipse of the +10° lenslet are almost identical to the parameters of the front ellipse of the −9.5° lenslet. Preferably the difference in absolute value between the substantially complimentary horizontal viewing angles of adjacent lenslet or sublenslet elements in a pixel pair is kept as small as possible. More preferably the difference in absolute value between the substantially complimentary horizontal viewing angles is identical to the spacing in horizontal viewing angles.

In FIG. 11 we see a pair of RGB subpixels, with freefrom sublenslet elements arranged for each subpixel, and where for the freeform sublenslet elements for the positive horizontal viewing angle are interleaved with freeform sublenslet elements for the substantially complimentary negative horizontal viewing angle. Red and blue subpixels of the first pixel, together with the green subpixel of the second pixel are deflected in a first horizontal direction, while the green subpixel of the first pixel and the red and blue subpixels of the second pixel are deflected in a second horizontal direction. Where the first horizontal direction and the second horizontal direction are substantially complementary.

In FIG. 12 we see the simulated result of the horizontal and vertical viewing angles achieved by a collimated pixel with a freeform lens surface designed with the forementioned approach for a horizontal viewing angle of 30° and a vertical range of viewing angles from −25° till +25°. The result approximates the target of a perfectly vertical strip of light in which the horizontal viewing angle is constant over the range of vertical viewing angles. The deviation of the horizontal angle over the range of vertical angles from −22° till +22° is smaller than the angular spacing of 0.5°. Only at the extreme vertical viewing angles (<−24° and >+24°) the deviation in horizontal angle becomes larger than the targeted tolerance of <1°.

For the same reason we want avoid steep transitions in the horizontal direction we also prefer to minimize steep transitions in the vertical direction. Preferably pixels delivering adjacent horizontal viewing angles are physically close to each other. Such an arrangement also guarantees that the multi-view pixel pitch within the same view is almost identical to the multi-view pixel pitch between adjacent views. This is important as the observer moves from one view to the next adjacent view, or when he observes a mixture of adjacent views.

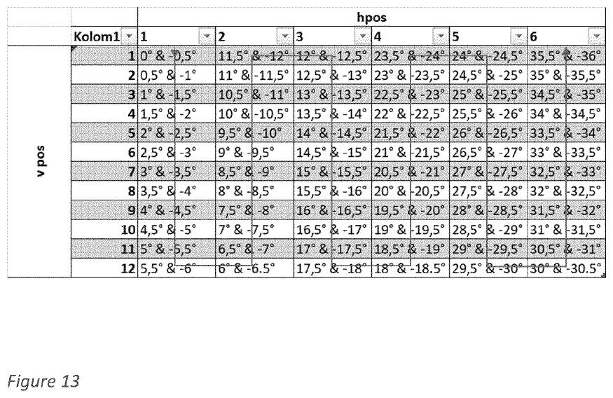

FIG. 13 illustrates a preferred embodiment for the 144-view display in which pixel pairs delivering nearly complimentary views are arranged in a vertical zigzag order of increasing absolute value of the horizontal viewing angle. Other arrangements are possible however with still acceptably small height difference between adjacent lenslet or sublenslet elements. It is clear that the image information of the 144-view image has to be mapped such that the information of each subpixel of the LCD 20 corresponds with the viewing direction defined by the corresponding freefrom lenslet or sublenslet element.

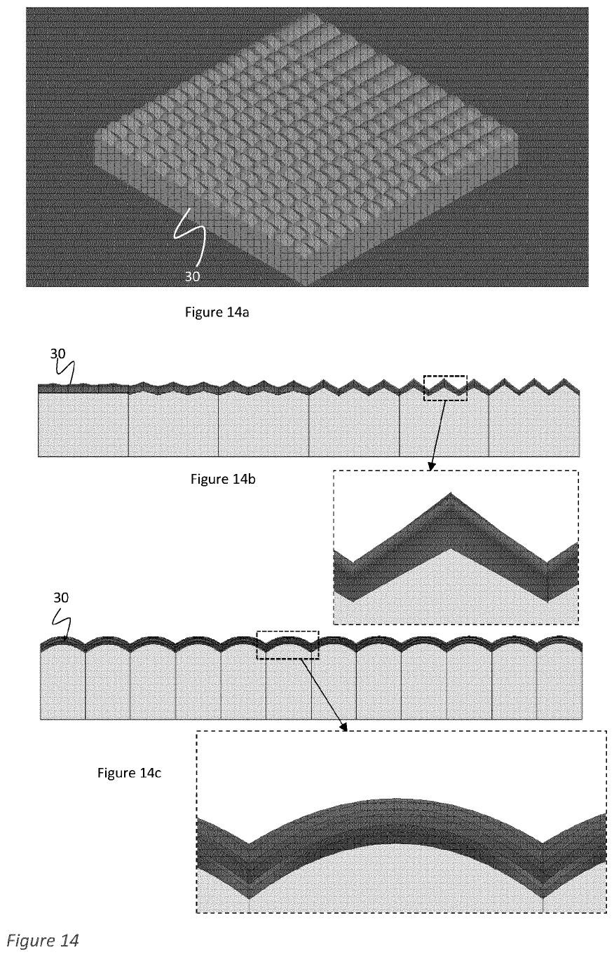

FIG. 14 illustrates a preferred embodiment of the freeform lenslet array 30 arranged for each vertical subpixel of a matrix of 12 horizontal by 12 pixels. With interleaving of elements for a positive horizontal viewing angle with elements for a substantially complementary negative horizontal viewing angle and where adjacent viewpairs are arranged in a vertical zigzag order of increasing horizontal viewing angle (absolute value). FIG. 14a illustrates a 3D view showing that steep transitions between adjacent lenslet or sublenslet elements are minimized in both horizontal and vertical direction. FIG. 14b illustrates a rear view showing that the lens sag (dark gray areas) is decreasing as the central tilt angle is increasing. In the detailed inset of FIG. 14b we can also see that for large horizontal tilt angles the central tilt angle is larger than the tilt angle at the edge. FIG. 14c illustrates the right sideview, in the detailed inset of FIG. 14c we can observe that the back ellipses become more shallow as the horizontal viewing angle is increasing.

To avoid reflections of ambient light from the freeform lenslet array 30, the lens surface preferably is treated with an anti-reflection coating for visible light, while the back surface preferably is laminated to the collimated multi-view pixel display using an index matched optically clear adhesive.

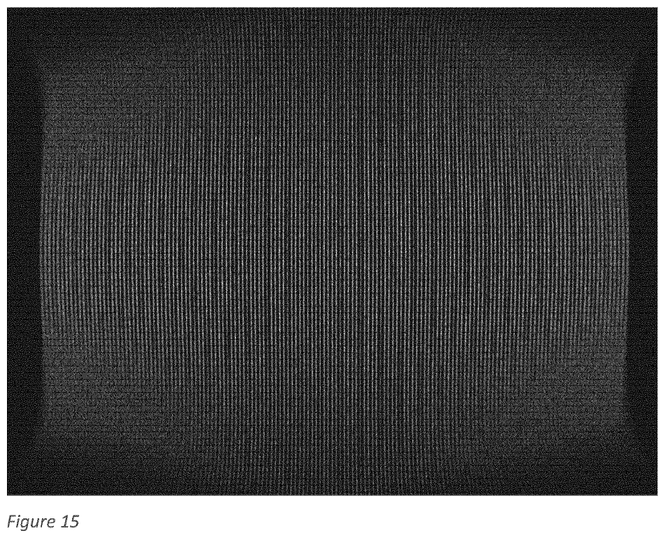

In FIG. 15 we see the simulated result with a fully collimated multi-view image of 12×12 pixels after passing through the freeform lenslet array 30 according to the preferred design described above and illustrated in FIG. 14. It delivers the 144 discrete viewing angles spaced apart with 0.5° steps.

The light is spread largely over the +/−25° vertical viewing angle in substantially vertical strips. For large horizontal angles, combined with large vertical angles there is still some deviation from the targeted vertical strip, among others because the elliptical approximation is not perfect.

While this clearly illustrates how the multi-view display configuration works, such a discrete separation between the different views is not desirable. It would mean that a viewer in front of the display would either observe view N, view N+1 or nothing at all. Since the observation angle gradually changes from the left side of the display to the right side of the display, this would translate into observing a white image element at constant depth (2D white field) as vertical bands of white information (at those locations where one of the discrete views is observable), interleaved with black information (at those locations in between the discrete views where nothing is observable).

It is therefore an object of the invention to control the degree of horizontal collimation of the collimated backlight precisely to close the gaps between adjacent horizontal viewing angles. The horizontal collimation angle (full angle) preferably is larger than or equal to the separation angle between adjacent horizontal views. In our design example >0.5°. At the same time it is preferable to only allow minimal overlap, and allow mixing only between adjacent views. The horizontal collimation angle (full angle) preferably is smaller than twice the separation angle between adjacent horizontal views. In our design example ≤ 1°. The horizontal angular intensity profile is chosen such that the sum of 2 adjacent intensity profiles is approximately constant over the angular range in between 2 horizontal views.

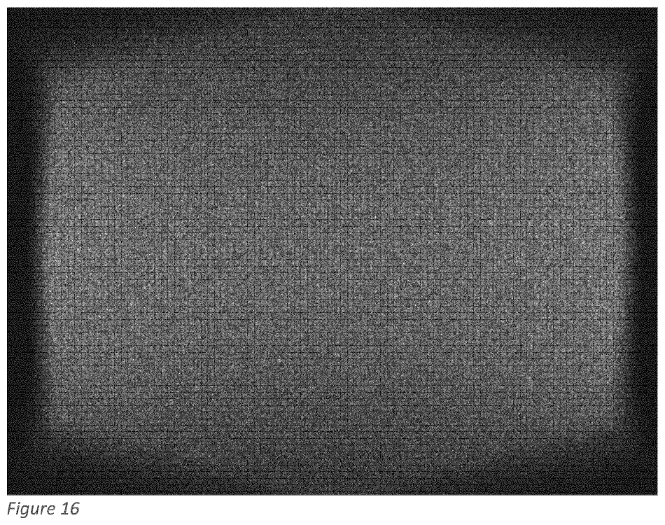

FIG. 16 shows the resulting intensity distribution from a 12×12 multi-view pixel after passing the freefrom lenslet array 30, when the horizontal collimation full angle is chosen to be 1° and a round aperture with gaussian angular distribution is assumed. We can now observe that the intensity is quite uniform over the entire range of horizontal and vertical viewing angles.

Even if the proposed approach enables to increase the number of horizontal views by reducing both horizontal and vertical resolution, the resolution that can be offered from a single 4k display is quite limited. It is a further object of the invention to increase the resolution of the multi-view image and increase the size of the display area by tiling multiple display elements together.

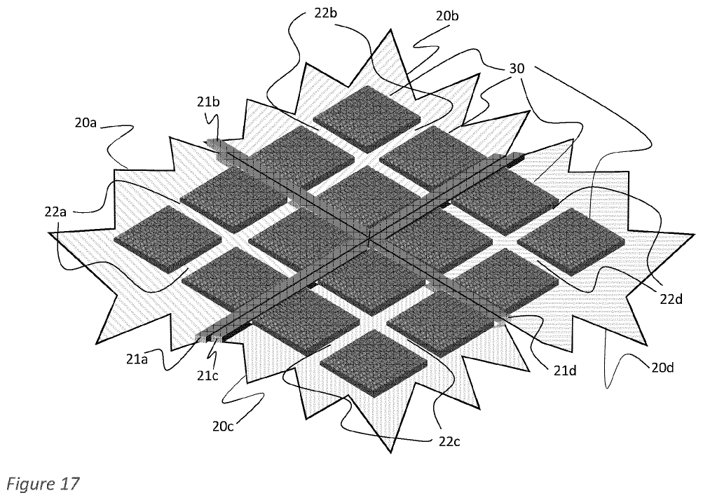

This is illustrated in FIG. 17. Four LCD's 20a , 20b , 20c and 20d are assembled together with a super narrow bezel (21a , 21b , 21c and 21d) in between. A freeform lenslet array 30 is positioned to cover the corner pixels. The collimated nature of the multi-view image is beneficial in order to avoid any light blockage from the bezels 21. Preferably the freeform lenslet array is higher than the height of the bezels 21, such that the full viewing angle can be observed. In order to be able to achieve a fully seamless multi-view image, the spacing resulting from the unavoidable bezels 21 between adjacent LCD's is repeated between every multi-view pixel. For example if the bezels are minimized to produce a 1 mm gap, we reserve 3 pixels of our 4k LCD (3×0.315 mm) to produce a virtual gap of unused black pixels 22. We install these virtual gaps 22 in horizontal and vertical direction. The pixel pitch between adjacent multiview pixels hence becomes 0.315×(12+3) mm in both horizontal and vertical direction. The resolution of our 4 k display is therefore divided by a factor 15 resulting in 256×144 multi-view pixels. While by introducing the virtual gap of unused black pixels 22 we sacrifice 20% of the available resolution and 36% of the display area, it results in a pixel structure and pixel pitch that is continuous across the tiled display surface.

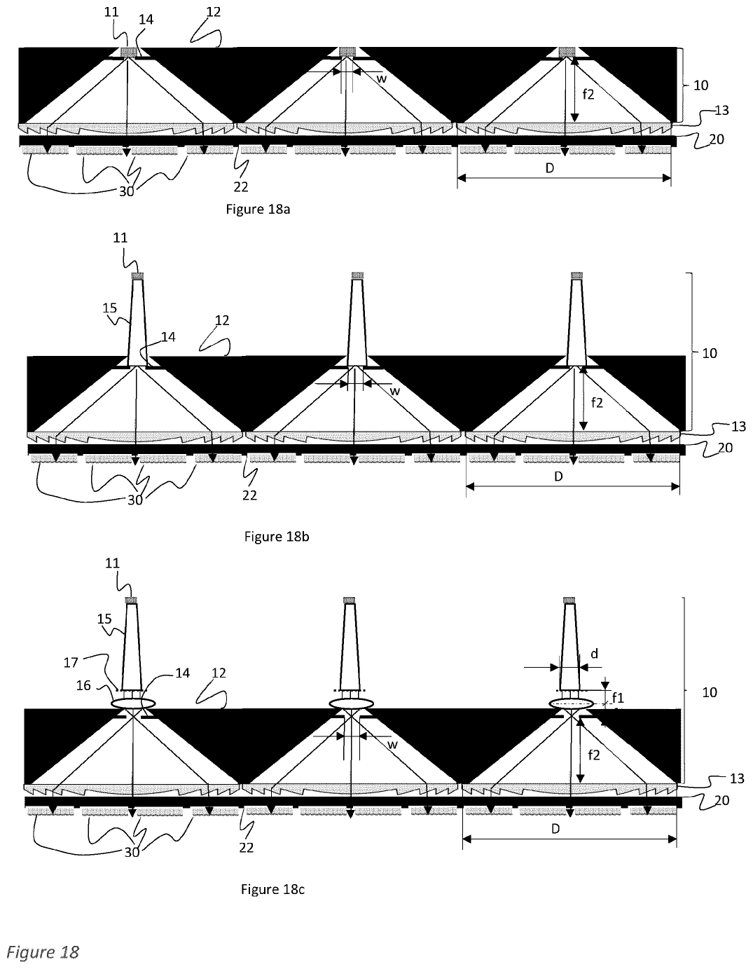

FIG. 18 illustrates 3 preferred implementations of the collimated backlight 10. An array of multiview pixels is grouped together for example 4 horizontal×4 vertical multiview pixels. Light from a lightsource 11 is collimated by Fresnel lens 13 with focal length f2. This structure is repeated in horizontal and vertical direction. In between each cell containing light source 11 and Fresnel lens 13, a light shield 12 of light absorbing material is installed to avoid that light from lightsource 11 can reach the Fresnel lens of the adjacent cell. The joint between adjacent Fresnel lenses 13 and the supporting light absorbing structure 12 preferably is aligned with a virtual gap of unused black pixels 22, to render transitions between adjacent Fresnel elements 13 and the absorbing light shield 12 invisible.

In the configuration of FIG. 18a, the light source 11 is positioned at the focal point (at distance f2 from Fresnel lens 13) of Fresnel lens 13 to achieve collimation. The light source 11 could for example be an LED light source. An aperture 14 may optionally be installed in front of light source 11. Without aperture 14, the dimensions of the light source 11 itself determine the aperture size and shape. The horizontal width w of either the aperture 14 or the light source 11 and the focal length f2 of the Fresnel lens 13 determine the degree of horizontal collimation. The full horizontal collimation angle is given by.

$$tan α = \frac{w}{f 2}$$

We select w and the focal length f2 of the Fresnel lens 13 to meet the desired horizontal collimation angle. In the example design 0.5°≤α≤1°.

The choice of the focal length f2 comes with a trade-off. A short focal length captures a bigger part of the emission angles from the light source 11, and also reduces the overall depth of the display. But as the intensity from the light source drops with larger emission angles, this means that pixels towards the side of Fresnel lens 13 will receive a lower intensity illumination. While this may be compensated electronically, it can only be done by reducing the pixel intensity and dynamic range in the center of the Fresnel lens. A short focal length f2 also results in increasing trapezoid distortion of a rectangular aperture 14 or lightsource 11 at larger angles. On the other hand a larger focal length f2 means that a smaller part of the emission angles from light source 11 is captured, while the remainder is absorbed by the light absorbing structure 12. And the depth of the display increases. Preferable the ratio D/f2 is in the range of 0.75 till 2.

A further preferred embodiment to increase the efficiency of the collimated backlight structure is illustrated in FIG. 18b, where a tapered uniformization rod 15 is installed between light source 11 and the focal plane of Fresnel lens 13. Because of the tapering the emission angles from the exit of light rod are reduced relative to the emission angles from the source 11. Tapering may be applied in a vertical only direction, in a horizontal only direction of both vertically and horizontally.

With an LED having a rectangular light emitting surface in the configuration of FIG. 18a or a rectangular light emitting exit surface of tapered integrator rod 15 in the configuration of FIG. 18b, with nearly constant intensity, the angular distribution in horizontal direction is approximately top-hat. To facilitate a smooth transition with constant intensity across horizontal viewing angles in between adjacent horizontal views, a limiting aperture 14 with optimized shape (for example a round or oval shape) may be installed at the focal plane of Fresnel lens 13.

FIG. 18c illustrates a further preferred embodiment to avoid the intensity roll-off towards the edges of Fresnel lens 13 by imaging the uniform square or rectangular illumination from light source 11 or the exit of tapered uniformization rod 15 by installing a fourier lens 16 in between the light emitting surface and the focal plane of Fresnel lens 13. The lens is installed at a distance equal to its focal length f1 from the light emitting surface and at the same distance f1 away from the focal plane of Fresnel lens 13. The magnification between the horizontal width of the light emitting surface d and the horizontal width of clustered multi-view pixels D is given by:

$$D = d \cdot \frac{f 2}{f 1}$$

Collimated light from the source is focused into the aperture plane. The light distribution at the aperture plane is now no longer expected to be uniform, but determined by the angular distribution of the light source, Therefore the angular distribution of the collimated light is expected to be gaussian rather than a top-hat profile. This may contribute to a smooth transition with constant intensity across horizontal viewing angles in between adjacent horizontal views. In addition, optionally a limiting aperture 14 with optimized shape (for example a round or oval shape) may be installed at the focal plane of Fresnel lens 13 to further finetune this transition.

FIG. 18c also illustrates a further possible optimization of the efficiency of the collimated backlight structure for use with an LCD display. A reflective polarizer 17 may be attached to either the lightsource 11 or to the exit of tapered uniformization rod 15. The reflective polarizer 17 being aligned to pass only light with polarization direction as required for the LCD display. Light with the wrong polarization is reflected back to the light source 11. When this light source 11 is a blue LED with yellow phosphor convertor, the blue light with the wrong polarization may be further converted by the phosphor layer. While the majority of the returned yellow light with the wrong polarization, will be diffusely reflected by the phosphor and get depolarized. The converted blue light and depolarized yellow light will get a second 50% chance to pass the reflective polarizer. After multiple passes the useful yellow light output with the desired polarization direction will be increased. Of course increasing the yellow output while maintaining the same blue output will shift the white point. The thickness of the phosphor layer on the LED may be reduced to change the native white point of the LED and achieve the desired white point after polarization recuperation of the yellow light. The reflective polarizer may be a wire-grid polarizer or a multilayer reflective polarizer such as the 3M DBEF foil.

The fact that the multi-view display is powered by a matrix of light sources 11, offers the opportunity to implement local dimming, thereby improving black level and saving energy consumption. In this case the dimming level is determined by the brightest view within the cluster of multi-view pixels powered by a single light source.

1. A horizontal parallax multi-view pixel element comprising:
a collimated pixel display portion of M horizontal by N vertical pixels, M×N pixels,
a freeform lenslet array covering said display portion, wherein
said freeform lenslet array is receiving collimated light from the collimated pixel display portion, and
said freeform lenslet array is comprising M×N lenslet elements that are aligned with said M×N pixels of said collimated pixel display portion,
wherein each of said M×N lenslet elements is directing light from a corresponding pixel from said collimated pixel display portion into one of M×N discrete horizontal viewing angles while spreading said light over a vertical viewing angle range.

2. The horizontal parallax multi-view pixel element according to claim 1, wherein said freeform lenslet array spreads light over a vertical viewing angle range with constant spacing between adjacent horizontal viewing angles.

3. The horizontal parallax multi-view pixel element according to claim 1, wherein light from each pixel is directed into a substantially constant discrete horizontal viewing angle while spreading the light in the vertical direction across a vertical strip of light into the viewing zone.

4. The horizontal parallax multi-view pixel element according to claim 3, wherein the spread of said discrete horizontal viewing angles over the range of vertical angles is preferably smaller than the angular spacing between adjacent horizontal views and at least smaller than twice the angular spacing between adjacent horizontal views.

5. The horizontal parallax multi-view pixel element according to claim 1, wherein each pixel comprises multiple subpixels and each lenslet element comprises 2 or more sublenslet elements.

6. The horizontal parallax multi-view pixel element according to claim 1, wherein each lenslet or sublenslet element of said freeform lenslet array is characterized-wherein by:
a. a horizontal tilt angle corresponding to a maximum vertical viewing angle that is smaller than the horizontal tilt angle corresponding to the central vertical viewing angle, with the difference between the two increasing with larger horizontal viewing angle,
b. a vertical tilt corresponding to the maximum vertical viewing angle decreasing with larger horizontal viewing angle, wherein the larger horizontal viewing angles means the absolute value of the horizontal viewing angle is larger.

7. The horizontal parallax multi-view pixel element according to claim 1, wherein each lenslet or sublenslet element of the freeform lenslet array has is:
a. a tilt of the horizontal centerline of the freeform surface increases with increasing horizontal viewing angle and of which said increase is slower than linear, and
b. a lens sag of the surface of said freeform lenslet or sublenslet element becomes smaller for large horizontal viewing angles.

8. The horizontal parallax multi-view pixel element according to claim 1, wherein the vertical cross sections of each lenslet or sublenslet element of said freeform lenslet array are substantially elliptical such that: a. the elliptical cross section at the high side of said lenslet or sublenslet element is more shallow then the elliptical cross section at the low side of the lenslet or sublenslet element;
b. both ellipses become more shallow as the horizontal viewing angle becomes larger.

9. A collimated multi-view pixel display, comprising horizontal parallax multi-view pixel elements according to claim 1, and wherein gaps between adjacent horizontal viewing angles are smaller than half of said collimation angle, or
wherein a horizontal angular profile being controlled to deliver approximately constant brightness over the entire range of horizontal viewing angles in between two adjacent horizontal views.

10. (canceled)

11. The horizontal parallax multi-view pixel element according to claim 1, wherein a pair of horizontally adjacent pixels are arranged to deliver substantially complementary horizontal viewing angles, and
wherein pixel pairs delivering substantially complementary views are arranged in a vertical zigzag order of increasing absolute value of horizontal viewing angle.

12. (canceled)

13. The horizontal parallax multi-view pixel element according to claims 9, wherein the collimated multi-view pixel display comprises a collimated backlight and an LCD display.

14. The horizontal parallax multi-view pixel element according to claim 13, wherein each pixel of the LCD display comprises multiple subpixels of different color.

15. The horizontal parallax multi-view pixel element according to claim 14, wherein the subpixels are arranged as vertical subpixels, and
wherein a first pixel and a second pixel are horizontally adjacent and each comprise red, green and blue vertical subpixels, and wherein the red and blue subpixels of the first pixel, together with the green subpixel of the second pixel are deflected in a first horizontal direction, while the green subpixel of the first pixel and the red and blue subpixels of the second pixel are deflected in a second horizontal direction, and wherein the first horizontal direction and the second horizontal direction are substantially complementary.

16. (canceled)

17. A tileable collimated multi-view pixel display comprising multi-view pixel elements according to claim 1, wherein:
a. a seam width between the edge pixels of two adjacent multi-view pixel displays is minimized, and
b. a virtual gap of unused black pixels with dimensions substantially equal to the width of said seam is repeated between adjacent multi-view pixel elements.

18. The collimated backlight structure for a tileable multi-view display according to claim 17 with a group of multi-view pixels clustered to be illuminated by a collimated backlight cell containing a lightsource, a collimation lens, the light source positioned at the focal plane of the collimation lens, and a light absorbing structure, wherein the joint between adjacent collimation lenses and light absorbing supporting structure are aligned with the virtual gap of unused black pixels.

19. The collimated backlight structure according to claim 18 further comprising a tapered rod installed after the light source to alter the emission angles in a vertical, horizontal or vertical and horizontal direction, the exit of the tapered rod positioned at the focal plane of the collimation lens.

20. The collimated backlight structure according to claim 18 for use with a polarized display, further comprising a reflective polarizer installed after the light source or after the tapered rod, wherein the reflective polarizer is aligned to pass only light with the proper polarization direction for the polarized display.

21. The collimated backlight structure according to claim 18 further comprising a fourier lens receiving the light from the light source or from the tapered rod and focusing the light into an aperture plane, wherein this aperture plane coincides with the focal plane of the collimation lens.

22. The collimated backlight structure according to claim 18, further comprising a round or oval shaped aperture at the focal plane of the collimation lens.

23. The collimated backlight structure according to claim 18, wherein the light source from each collimated backlight cell may be individually dimmed and the dimming level is determined by the brightest view within the cluster of multi-view pixels.
